(19) United States
(12) Patent Application Publication
(10) Pub. No.: US 2009/0222309 A1
(43) Pub. Date: Sep. 3, 2009

(54) System and Method for Notifying Multiple Devices of Impending Events

(75) Inventors: Leonardo Velazquez, Plano, IL (US); Sudha Gopal, Plano, TX (US); Anthony F. Bonvolanta, Chicago, IL (US)

Correspondence Address: AT&T Legal Department - LNAP;Attn: Patent Docketing, Room 2A- 207, One AT & T Way, Bedminster, NJ, 07921, US

(73) Assignee: AT&T INTELLECTUAL PROPERTY, LP, Reno, NV (US)

(21) Appl. No.: 12/039,425

(22) Filed: Feb. 28, 2008

(51) Int. Cl. G06Q 10/00; G06Q 99/00

(52) U.S. Cl. 705/8; 705/1

(57) ABSTRACT

An event notification system includes a provision module, a scheduling module, and a notification module. The provision module is adapted to determine multiple types of devices associated with subscribed services of a user account. The scheduling module is adapted to store a calendar event, and further adapted to generate an impending event signal based upon an impending occurrence of the calendar event. The notification module is in communication with the provision module and the scheduling module. The notification module is adapted receive the impending event signal, adapted to retrieve the multiple types of devices associated with the subscribed services of the user account, adapted to determine which of the multiple types of devices are in current communication with the system, and adapted to send an event notification message to the devices that are in current communication with the system based upon receiving the impending event signal.

### FIELD OF THE DISCLOSURE

The present disclosure generally relates to communications networks, and more particularly relates to notifying multiple devices of impending events.

### BACKGROUND

Individuals can use electronic calendars to schedule upcoming events, and can be notified or reminded by the electronic calendars about the event prior to the event taking place. Individuals can own multiple computers, personal digital assistants (PDAs), cellular telephones, and other similar electronic devices each with a different electronic calendar. To receive an event notification message on every electronic device, the individual has to either enter the event on the calendar of each of the devices or have software to synchronize the devices.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of an event notification system;

FIG. 2 is an exemplary screen shot of an embodiment of an event scheduling graphical user interface;

FIG. 3 is a flow diagram of a method for storing an event in the event notification system;

FIG. 4 is a flow diagram of a method for sending an event notification message; and

FIG. 5 is a block diagram of a general computer system.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others.

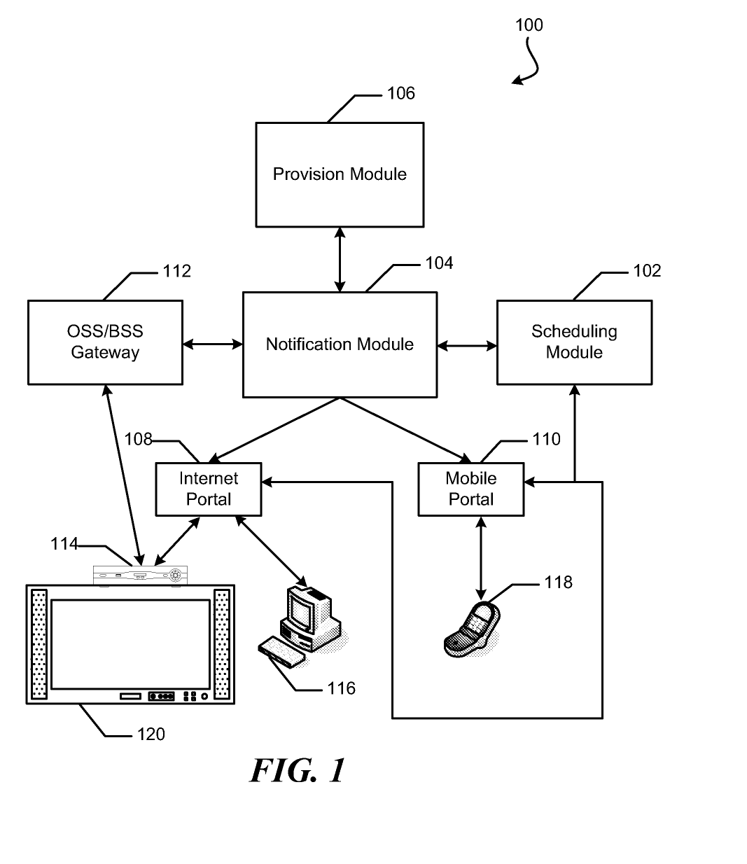

FIG. 1 shows a block diagram of an event notification system 100 including a scheduling module 102, a notification module 104, and a provision module 106. The event notification system 100 also includes an Internet portal 108, a mobile portal 110, and an operational support systems/business support systems (OSS/BSS) gateway 112. The scheduling module 102 is in communication with the notification module 104, the Internet portal 108, and the mobile portal 110. The notification system 104 is in communication with the provision module 106, the Internet portal 108, the mobile portal 110, and the OSS/BSS gateway 112. The Internet portal 108 is in communication with a set-top box 114 and a personal computer 116. The mobile portal 110 is in communication with a mobile device such as a cellular telephone 118. The OSS/BSS gateway is in communication with the set-top box 114.

The scheduling module 102 can receive a scheduling request for an event from multiple types of devices, such as the set-top box 114, the personal computer 116, and the cellular telephone 118. In response to the scheduling request, the scheduling module 102 can store information associated with the event such as its date, time, title, description, intended recipients, and the like. The scheduling module 102 can also store a reminder time for the event, which is the time set to notify the user about the impending occurrence of the event. The reminder time can be set for any amount of time prior to the actual occurrence of the event, such as minutes, hours, days, weeks, and the like. At the reminder time, the scheduling module 102 can send the notification module 104 an impending event signal.

The provision module 106 can store subscribed services associated with the user account scheduling the event, as well as the number and/or type of devices associated with the subscribed services. Thus, the subscribed services can include an Internet Protocol television (IPTV) service, a home telephone service, a cellular telephone service, an Internet service, and the like. Upon receiving the impending event signal from the scheduling module 102, the notification module 104 can retrieve the subscribed services along with the devices associated with the services, such as the number of cellular telephones and the number of set-top boxes. The notification module 104 or another part of the event notification system 100 can also determine whether the devices associated with the services are in current communication with the event notification system 100. The notification module 104 can also determine whether the devices that are in current communication with the event notification system 100 are able to receive notifications. For example, a device can be in current communication with the event notification system 100, but its ability to receive notifications could be disabled. Thus, even though the device is in current communication with the notification system 100, the device will not receive a notification from the notification module 104 unless notifications are re-enabled on the device.

Upon determining the devices of the user account that are in current communication with the event notification system 100 and that are enabled to receive notifications, the notification module 104 can retrieve the date, time, title, and any other available information about the event from the scheduling module 102. The notification module 104 can use this information to create an event notification message that can be sent to multiple types of devices of the user account, such as the set-top box 114, the personal computer 116, and the cellular telephone 118, to notify the user about the impending occurrence of the stored event. The event notification message can be a text message, a pop-up message, an electronic mail message, a television crawl, and the like.

The Internet portal 108 can provide the set-top box 114 and the personal computer 116 with access to the event notification system 100. The mobile portal 110 can provide the cellular telephone 116 with access to the scheduling module 102 and the notification module 104. The OSS/BSS gateway 112 can provide additional access from the set-top box 114 to the notification module 104. The notification module 104 can access the Internet portal 108, the mobile portal 110, and the OSS/BSS gateway 112 to determine which of the devices are in current communication with the event notification system 100.

While accessing the event notification system 100, the user can be presented with a graphical user interface (GUI) for navigation on a display device associated with the device, such as a television 120 when the device is the set-top box 114. Upon accessing the scheduling module 102, the user can set upcoming events and the number of devices to receive the event notification messages. The user can also delete a stored event or edit information associated with the stored events through the scheduling module 102. Upon the occurrence of the reminder time, the scheduling module 102 can send the notification module 104 the impending event signal and a Media Access Control (MAC) address and/or an Internet Protocol (IP) address for the devices set to receive the event notification message. The MAC address and IP address for a device provides the notification module 104 with the ability to know where in a network to send the event notification message.

Depending on the embodiment, the scheduling module 102 can receive multiple intended recipients to be notified about the impending occurrence of the event. The intended recipients can be part of the same user account and be different users on the user account, such as parents and children of a family account. The scheduling module 102 can also store any devices associated with each intended recipient to be notified about an impending occurrence of the event. Each recipient may have any combination of their own set-top box, personal computer, and cellular telephone, and the recipient may want to receive the event notification message on all of the devices. Upon receiving the impending event signal from the scheduling module 102, the notification module 104 can determine the devices for each of the intended recipients that are in current communication with the notification system 100 with notifications enabled to send the notification message.

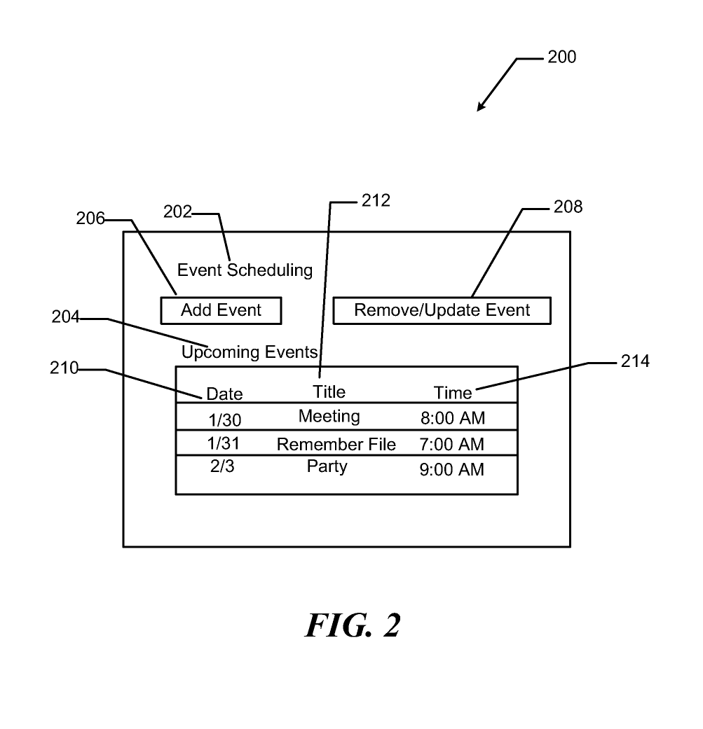

FIG. 2 shows an exemplary embodiment of an event scheduling GUI 200 including a title 202, a subtitle 204, an add event button 206, and a remove/update event button 208. The event scheduling GUI can be displayed on a display device associated with the set-top box 114, the computer 116, and the cellular telephone 118. Under the subtitle 204, the event scheduling GUI 200 also includes a date heading 210, a title heading 212, and a time heading 214. The title 202 can inform the user that he or she is accessing the event scheduling module 102. The subtitle 204 can inform the user that there are upcoming events scheduled. The add event button 206 and the remove/update event button 208 can be soft buttons that are adapted to be highlighted and selected by the set-top box 114, the personal computer 116, and the cellular telephone 118.

Upon the selection of the add event button 206, the event scheduling GUI 200 can change to provide the user with the ability to schedule a new event for the user account. While scheduling a new event, the user can enter the date, time, title, description, and the like for the event, which is displayed on the event scheduling GUI 200. Additionally, upon the selection of the remove/update event button 208, the event scheduling GUI 200 can change to present the user with a list of the stored events. The user can select a stored event and change the information associated with the stored event, such as time, date, title, description, intended recipients, and the like. The user can also select a stored event and delete the stored event from the scheduling module 102.

On the event scheduling GUI 200, the stored events can be displayed under the subtitle 204. The date heading 210 can indicate the date that the event is scheduled to occur. The title heading 212 can provide the user with the title of the event, such as meeting, remember file, party, and the like. The time heading 214 can provide the user with the time that the event is set to take place. The user can navigate through the event scheduling GUI 200 to set new events, view stored events, and remove/update stored events. The information entered by the user through the event scheduling GUI 200 can be stored in the scheduling module 102.

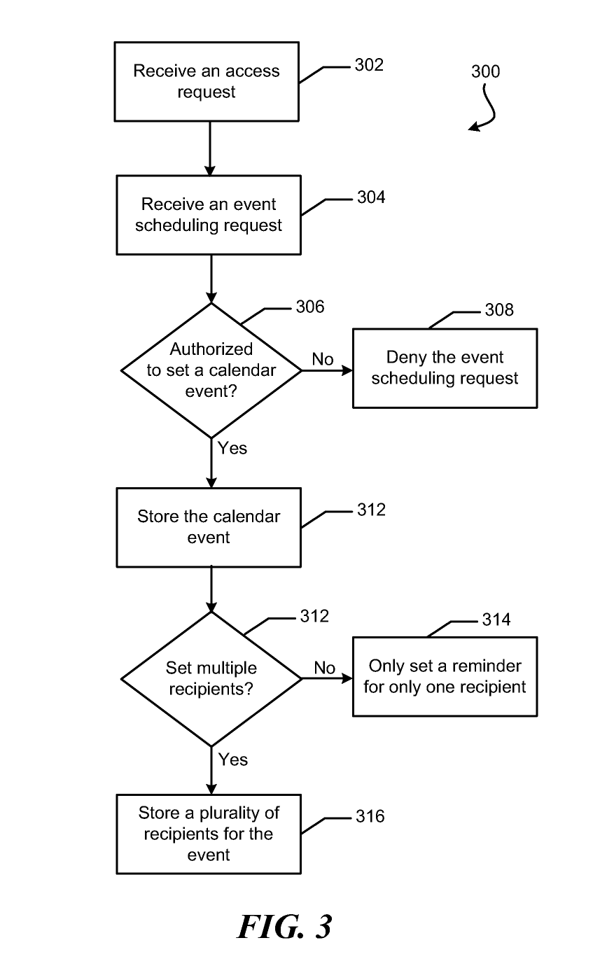

FIG. 3 shows a flow diagram of a method 300 for storing information associated with a calendar event. At block 302, an access request is received. The access request can be received from the set-top box, the personal computer, the cellular telephone, a Wireless Fidelity (Wi-Fi) device, and the like. An event scheduling request is received at block 304. At block 306, a determination is made whether a user is authorized to set a calendar event. A user account can have multiple users and each user can have a different authorization level, such as an account owner or a sub-account. For example, if the account is a household, the parents can have the ability to set reminders and other events for everyone in the family, but the children might only have the ability to set events for themselves. If the user is not authorized to set the calendar event, the event scheduling request is denied at block 308. At block 310, if the user is authorized to set the calendar event, the calendar event is stored. A determination is made whether multiple recipients are requested for the event notification message at block 312. If multiple recipients are not requested, then a reminder is stored only for the user setting the event at block 314. However, if multiple recipients are requested, the event reminder is stored for a plurality of recipients at block 316.

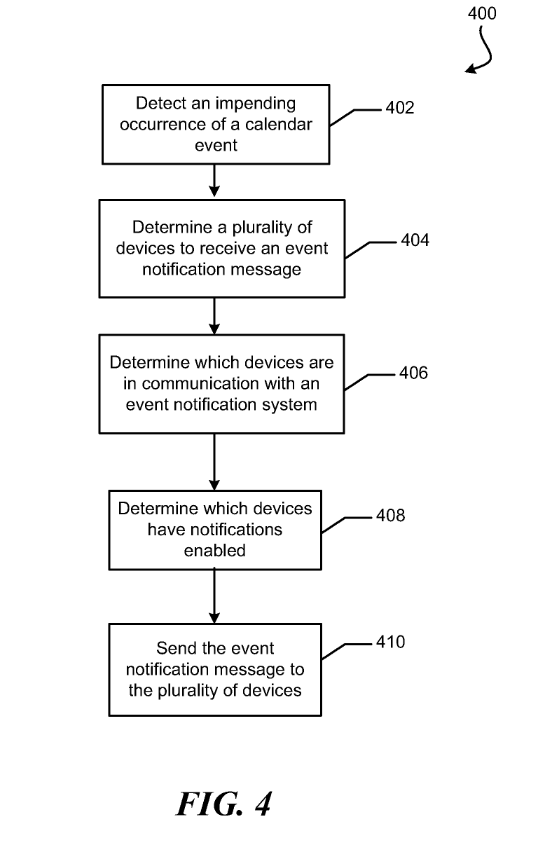

FIG. 4 shows a flow diagram of a method 400 for sending an event notification message. At block 402, an impending occurrence of a calendar event is detected. A plurality of devices to receive an event notification message is determined at block 404. At block 406, the devices that are in current communication with the event notification system are determined. The devices that have the notifications enabled are determined out of the devices that are in current communication with the event notification system at block 408. At block 410, the event notification message is sent to the devices that are in current communication with the event notification system and that have the notifications enabled.

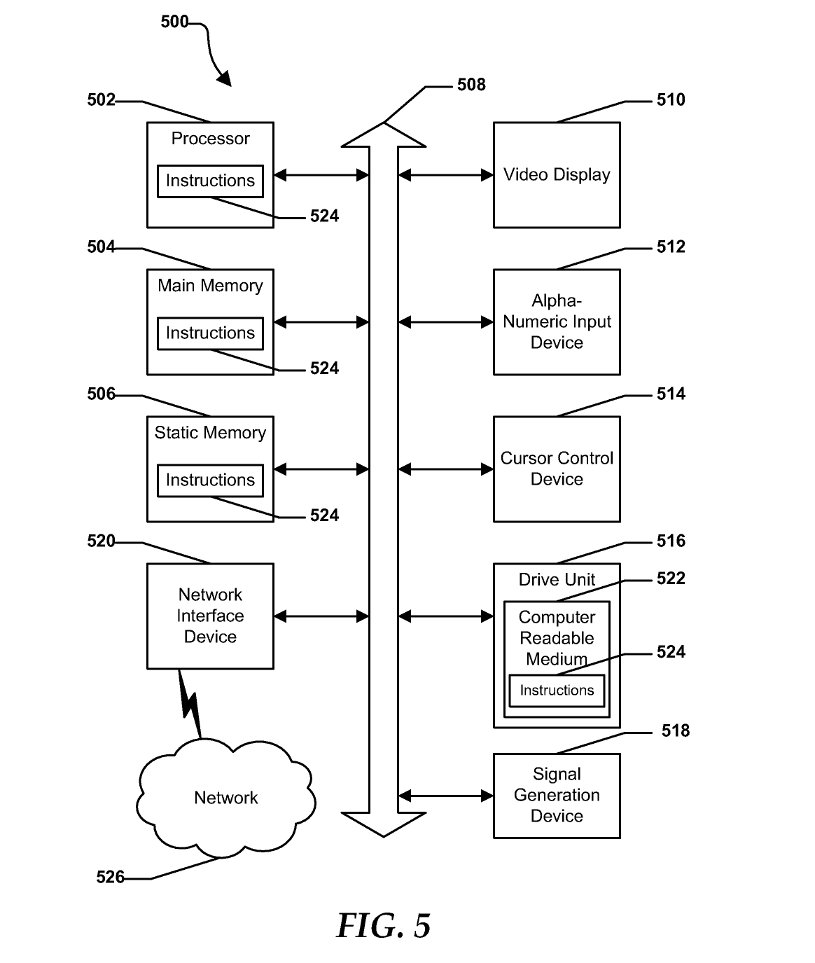

FIG. 5 shows an illustrative embodiment of a general computer system 500 in accordance with at least one embodiment of the present disclosure. The computer system 500 can include a set of instructions that can be executed to cause the computer system to perform any one or more of the methods or computer based functions disclosed herein. The computer system 500 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 500 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 500 can be implemented using electronic devices that provide voice, video or data communication. Further, while a single computer system 500 is illustrated, the term “system” shall also be taken to include any collection of systems or sub-systems that individually or jointly execute a set, or multiple sets, of instructions to perform one or more computer functions.

The computer system 500 may include a processor 502, e.g., a central processing unit (CPU), a graphics processing unit (GPU), or both. Moreover, the computer system 500 can include a main memory 504 and a static memory 506 that can communicate with each other via a bus 508. As shown, the computer system 500 may further include a video display unit 510, such as a liquid crystal display (LCD), an organic light emitting diode (OLED), a flat panel display, a solid state display, or a cathode ray tube (CRT). Additionally, the computer system 500 may include an input device 512, such as a keyboard, and a cursor control device 514, such as a mouse. The computer system 500 can also include a disk drive unit 516, a signal generation device 518, such as a speaker or remote control, and a network interface device 520.

In a particular embodiment, as depicted in FIG. 5, the disk drive unit 516 may include a computer-readable medium 522 in which one or more sets of instructions 524, e.g. software, can be embedded. Further, the instructions 524 may embody one or more of the methods or logic as described herein. In a particular embodiment, the instructions 524 may reside completely, or at least partially, within the main memory 504, the static memory 506, and/or within the processor 502 during execution by the computer system 500. The main memory 504 and the processor 502 also may include computer-readable media. The network interface device 520 can provide connectivity to a network 526, e.g., a wide area network (WAN), a local area network (LAN), or other network.

In an alternative embodiment, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 524 or receives and executes instructions 524 responsive to a propagated signal, so that a device connected to a network 526 can communicate voice, video or data over the network 526. Further, the instructions 524 may be transmitted or received over the network 526 via the network interface device 520.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the FIGs. are to be regarded as illustrative rather than restrictive.

The Abstract of the Disclosure is provided to comply with 37 C.F.R. §1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A system comprising:
a provision module adapted to determine multiple types of devices associated with subscribed services of a user account;
a scheduling module adapted to store a calendar event, and further adapted to generate an impending event signal based upon an impending occurrence of the calendar event; and
a notification module in communication with the provision module and the scheduling module, the notification module adapted receive the impending event signal, adapted to retrieve the multiple types of devices associated with the subscribed services of the user account, adapted to determine which of the multiple types of devices are in current communication with the system, and adapted to send an event notification message to the devices that are in current communication with the system based upon receiving the impending event signal.

2. The system of claim 1 further comprising:
a portal in communication with the notification module, the portal adapted to provide the notification module and the scheduling module with communication to the multiple types of devices.

3. The system of claim 1 wherein the scheduling module is further adapted to restrict an ability to set the calendar event based on an authorization level.

4. The system of claim 1 wherein the multiple types of devices include a set-top box, a personal computer, and a cellular telephone.

5. The system of claim 1 wherein the notification module is further adapted to determine if one of the multiple types of devices has disabled notifications.

6. The system of claim 1 wherein the provision module is further adapted to determine the subscribed services of the user account.

7. The system of claim 6 wherein the subscribed services include an Internet Protocol television service, a cellular telephone service, and an Internet data service.

8. The system of claim 1 wherein the event notification message is selected from a group consisting of a text message, an electronic mail message, a pop-up message, and a television crawl message.

9. A method comprising:
detecting an impending occurrence of a calendar event;
determining multiple types of devices associated with subscribed services of a user account to receive an event notification message for the calendar event;
determining which of the multiple types of devices are in current communication with a notification system; and
sending the event notification message to the devices that are in current communication with the system.

10. The method of claim 9 wherein the multiple types of devices include a set-top box, a personal computer, and a cellular telephone.

11. The method of claim 9 further comprising:
receiving an event scheduling request for the calendar event prior to detecting the impending occurrence of the calendar event;
determining an authorization level associated with the event scheduling request; and
allowing the event scheduling request based on the authorization level.

12. The method of claim 11 wherein the authorization level is selected from a group consisting of an account owner and a sub-account.

13. The method of claim 9 wherein the calendar event is selected from a group consisting of a reminder, a meeting, and a party.

14. The method of claim 9 wherein the event notification message is selected from a group consisting of a text message, an electronic mail message, a pop-up message, and a television crawl message.

15. A computer readable medium comprising a plurality of instructions to manipulate a processor, the plurality of instructions comprising:
instructions to detect an impending occurrence of a calendar event;
instructions to determine multiple types of devices associated with subscribed services of a user account to receive an event notification message for the calendar event;
instructions to determine which of the multiple types of devices are in current communication with a notification system; and
instructions to send the event notification message to the devices that are in current communication with the system.

16. The computer readable medium of claim 15 wherein the multiple types of devices include a set-top box, a personal computer, and a cellular telephone.

17. The computer readable medium of claim 15 further comprising:
instructions to receive an event scheduling request prior to the instructions to detect the impending occurrence of the calendar event;
instructions to determine an authorization level associated with the event scheduling request; and
instructions to allow the event scheduling request based on the authorization level.

18. The computer readable medium of claim 17 wherein the authorization level is selected from a group consisting of an account owner and a sub-account.

19. The computer readable medium of claim 15 wherein the calendar event is selected from a group consisting of a reminder, a meeting, and a party.

20. The computer readable medium of claim 15 wherein the event notification message is selected from a group consisting of a text message, an electronic mail message, a pop-up message, and a television crawl message.
